(19) United States
(12) Patent Application Publication
(10) Pub. No.: US 2023/0046570 A1
(43) Pub. Date: Feb. 16, 2023

(54) METHOD AND NETWORK ENTITY FOR SERVICE API PUBLISHING

(71) Applicant: Telefonaktiebolaget LM Ericsson (publ), Stockholm (SE)

(72) Inventor: Wenliang Xu, Shanghai (CN)

(21) Appl. No.: 17/793,072

(22) PCT Filed: Nov. 20, 2020
(86) PCT No.: PCT/EP2020/082923

§ 371 Date: Jul. 15, 2022

(30) Foreign Application Priority Data
Feb. 14, 2020 (CN) PCT/CN2020/075379

(51) Int. Cl. G06F 9/54

(52) U.S. Cl. CPC G06F 9/547

(57) ABSTRACT

The present disclosure provides a method in a first network entity for service Application Programming Interface, API, publishing. The method includes: receiving, from a second network entity, an API publish request for publishing a service API, the API publish request containing a list of identifiers of network entities that have published the service API; and transmitting, when an identifier of the first network entity is included in the list, an API publish response indicating failure of publishing of the service API to the second network entity, without creating a new resource for the service API at the first network entity or further publishing the service API to any network entity.

### TECHNICAL FIELD

The present disclosure relates to communication technology, and more particularly, to a method and a network entity for service Application Programming Interface (API) publishing.

### BACKGROUND

With the growing interest in the 3^{rd} Generation Partnership Project (3GPP) to develop northbound APIs, a Common API Framework (CAPIF) allows for a consistent development of northbound APIs across multiple working groups, i.e., for defining northbound APIs to abstract or expose the underlying 3GPP network capabilities to the 3^{rd} party applications. The CAPIF offers a common framework for northbound APIs with respect to API registration, authentication, discovery, logging, and charging.

In the 3GPP Release 16, the CAPIF is enhanced with interconnection between different CAPIF provider domains or within the same CAPIF provider domain. FIG. 1 shows an architectural model for the CAPIF interconnection which allows API invokers of a CAPIF provider to utilize service APIs from the 3^{rd} party CAPIF provider. FIG. 2 shows an architectural model for the CAPIF interconnection within the same CAPIF provider domain, which allows API invokers of CAPIF Core Function (CCF) 1 to utilize service APIs from CCF 2, where both CCFs are hosted within the trust domain of the CAPIF provider A. In FIG. 1, the two CCFs are connected with each other via a CAPIF-6e interface (reference point); while in FIG. 2, the two CCFs are connected with each other via a CAPIF-6 interface (reference point). The CAPIF-6/6e interface supports publishing and discovering service API information. For service API publishing, the API Publishing Function (APF) (which enables the API provider to publish service API information to the CCF in order to enable discovery of service APIs by API invokers) or CCF can indicate Shareable Information in an API publish request or interconnection API publish request, such information indicates whether the service API can be shared and if shared, shared with which CAPIF provider domains. For further details of these and other functional entities, interfaces (reference points), API publish request and response, and interconnection API publish request and response, reference can be made to 3GPP Technical Specification (TS) 23.222, V16.6.0, which is incorporated herein by reference in its entirety.

### SUMMARY

It is an object of the present disclosure to provide a method and a network entity for service API publishing.

According to a first aspect of the present disclosure, a method in a first network entity for service API publishing is provided. The method includes: receiving, from a second network entity, a first API publish request for publishing a service API, the first API publish request containing a list of identifiers of network entities that have published the service API; and the method further includes: transmitting, when an identifier of the first network entity is included in the list, an API publish response indicating failure of publishing of the service API to the second network entity, without creating a new resource for the service API at the first network entity or further publishing the service API to any network entity, or transmitting, when an identifier of the first network entity is not included in the first list, a second API publish request for publishing the service API to a third network entity, the second API publish request containing a second list of identifiers of network entities obtained by adding the identifier of the first network entity to the first list.

In an embodiment, the second API publish request may be transmitted in response to determining that an identifier of the third network entity is not included in the first list.

In an embodiment, the method may further include, when the identifier of the first network entity is not included in the first list: creating a new resource for the service API at the first network entity; and transmitting, to the second network entity, an API publish response indicating success of publishing of the service API and containing an identifier of the created new resource.

In an embodiment, each of the first network entity, the second network entity, the third network entity, and the network entities that have published the service API may be a CCF entity.

In an embodiment, the first network entity, the second network entity, the third network entity, and the network entities that have published the service API may all be in one single CAPIF provider domain.

According to a third aspect of the present disclosure, a method in a first network entity for service API publishing is provided. The method includes: receiving, from a function entity, a first API publish request for publishing a service API; and transmitting a second API publish request for publishing the API to a second network entity, the second API publish request containing an identifier of the first network entity.

In an embodiment, each of the first network entity and the second network entity may be a CCF entity, and the function entity may be an APF entity.

In an embodiment, the first network entity and the second network entity may both be in one single CAPIF provider domain.

According to a fourth aspect of the present disclosure, a first network entity is provided. The first network entity includes a communication interface, a processor and a memory. The memory stores instructions executable by the processor whereby the first network entity is operative to perform the method according to the above first, second and/or third aspect.

According to a fifth aspect of the present disclosure, a computer readable storage medium is provided. The computer readable storage medium has computer program instructions stored thereon. The computer program instructions, when executed by a processor in a first network entity, cause the first network entity to perform the method according to the above first, second and/or third aspect.

According to a sixth aspect of the present disclosure, a communication system is provided. The communication system includes an APF entity, and a plurality of CCF entities. The APF entity is configured to transmit an API publish request for publishing a service API to one of the plurality of CCF entities. Each of the plurality of CCF entities is configured to perform the method according to the above first, second and/or third aspect.

With the embodiments of the present disclosure, upon receiving an API publish request for publishing a service API, a network entity can determine whether its identifier is included in a list of identifiers of network entities that have published the service API (if contained in the API publish request). When its identifier is included in the list, the network entity will respond with a result indicating failure of publishing of the service API, without creating a new resource for the service API or further publishing the service API to any network entity. On the other hand, only when its identifier is not included in the list, the CCF entity will create a new resource for the service API and/or transmit a further API publish request for publishing the service API to another network entity. The further API publish request can contain an updated list of identifiers of network entities that have published the service API, with the identifier of the network entity added to the list. In this way, the network entity can avoid creating redundant resources for the same service API and can prevent a loop for publishing the serving API.

### BRIEF DESCRIPTION OF THE DRAWINGS

The above and other objects, features and advantages will be more apparent from the following description of embodiments with reference to the figures, in which:

FIG. 1 is a schematic diagram showing an architectural model for a CAPIF interconnection across different CAPIF provider domains;

FIG. 2 is a schematic diagram showing an architectural model for a CAPIF interconnection within one CAPIF provider domain;

FIG. 3 is a schematic diagram showing an example of a loop for publishing a service API;

FIG. 4 is a flowchart illustrating a method for service API publishing according to an embodiment of the present disclosure;

FIG. 5 is a flowchart illustrating a method for service API publishing according to another embodiment of the present disclosure;

FIG. 6 is a sequence diagram showing an exemplary process for service API publishing according to an embodiment of the present disclosure;

FIG. 7 is a block diagram of a network entity according to an embodiment of the present disclosure; and

FIG. 8 is a block diagram of a network entity according to another embodiment of the present disclosure.

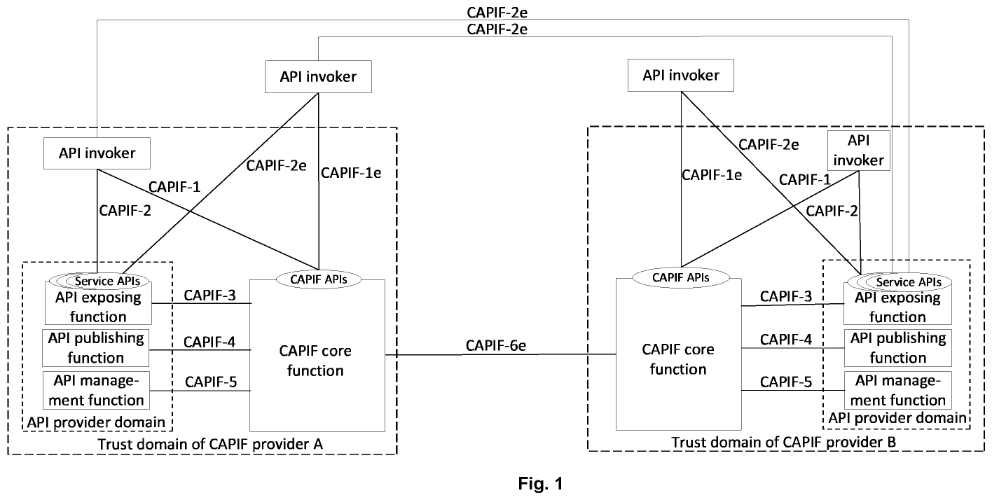

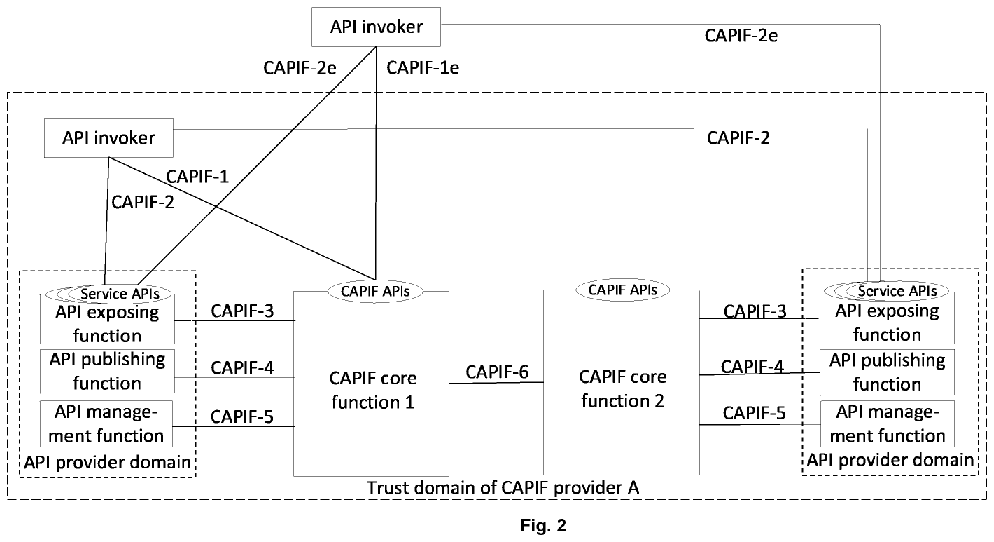

### DETAILED DESCRIPTION

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

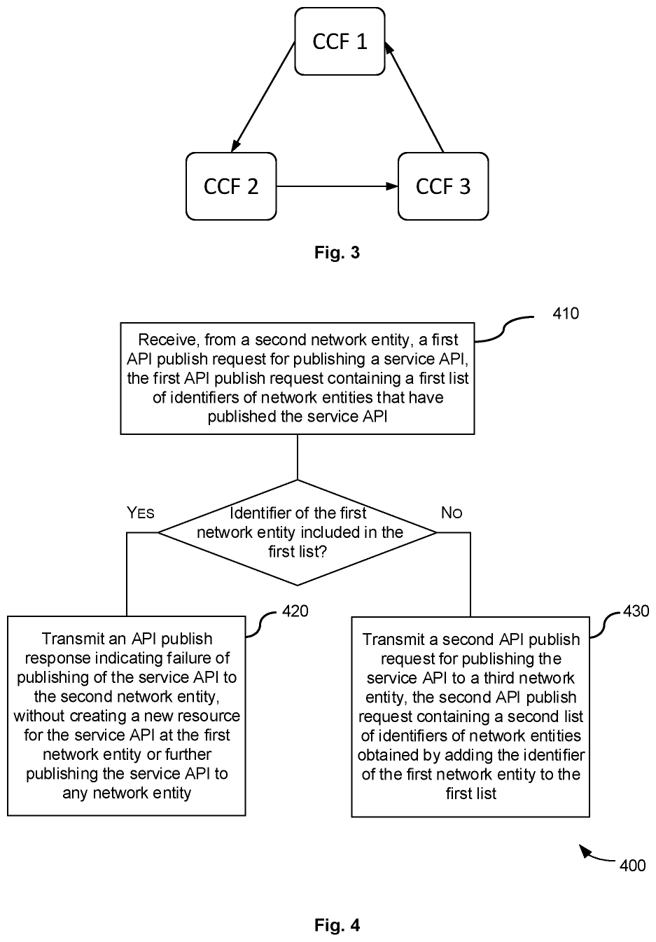

For service API publishing via CAPIF-6/6e interfaces, as shown in FIG. 3, it is possible that an API is first published from CCF 1 to CCF 2, then from CCF 2 to CCF 3, and then from CCF 3 back to CCF 1. In this case, CCF 1 will create a new service API resource for the API, in addition to the service API resource it has created when the API is initially published, e.g., from an APF. Thus, CCF 1 will have redundant resources occupied by the same API. More seriously, CCF 1 may again publish the API to CCF 2, which then may publish the API to CCF 3, and so on and so forth, resulting in a loop of service API publishing.

FIG. 4 is a flowchart illustrating a method 400 for service API publishing according to an embodiment of the present disclosure. The method 400 can be performed at a first network entity, e.g., a CCF entity.

At block 410, a first API publish request for publishing a service API is received from a second network entity (e.g., a CCF entity). The first API publish request contains a first list of identifiers of network entities (e.g., CCF entities) that have published the service API. In this context, the list can also be referred to as a “published API path”, or “API path” for short.

Here, the first API publish request can be an interconnection API publish request as specified in Section 8.25.2 of TS 23.222. Table 8.25.2.1-1 of TS 23.222 defines Information Elements (IEs) in the interconnection API publish request, which is reproduced as Table 1 below:

TABLE 1
Interconnection API publish request

| Information element | Status | Description |
|---|---|---|
| CCF information | M | The information of the CAPIF core function which |
| | | publishes APIs, may include identity, authentication |
| | | and authorization information |
| Service API information | O | The service API information includes the service |
| | (see NOTE 1) | API name, service API type, communication type, |
| | | description, interface details (e.g. IP address, port |
| | | number, URI), protocols, version numbers, and |
| | | data format. |
| Service API category | O | The category of the service APIs to be published, |
| | (see NOTE 1) | (e.g., V2X, IoT) |
| Shareable information | O | Indicates whether the service API or the service |
| | (see NOTE 2) | API category can be published to other CCFs. And |
| | | if sharing, a list of CAPIF provider domain |
| | | information where the service API or the service |
| | | API catetory can be published is contained. |
| CAPIF provider domain | O | Indicates the CAPIF provider domain of the service |
| information | (see NOTE 3) | API to be published |

NOTE 1:
At least one of the Service API information and Service API category shall be present.
NOTE 2:
If the shareable information is not present, the service API is not allowed to be shared.
NOTE 3:
This is only presented when publish service API to a different CAPIF provider domain.

The service API information in the above Table 8.25.2.1-1 is defined in detail in Table 8.2.4.2.2-1 of TS 29.222 V16.1.0, which can be changed to include the API path, as shown in Table 2 below:

TABLE 2
Definition of type ServiceAPIDescription

| Attribute | | | | | Applica- |
|---|---|---|---|---|---|
| name | Data type | P | Cardinality | Description | bility |
| apiName | string | M | 1 | API name, it is set as {apiName} part of the | |
| | | | | URI structure as defined in subclause 4.4 of | |
| | | | | 3GPP TS 29.501 [18]. | |
| apiId | string | O | 0 . . . 1 | API identifier assigned by the CAPIF core | |
| | | | | function to the published service API. Shall | |
| | | | | not be present in the HTTP POST request | |
| | | | | from the API publishing function to the | |
| | | | | CAPIF core function. Shall be present in | |
| | | | | the HTTP POST response from the CAPIF | |
| | | | | core function to the API publishing function | |
| | | | | and in the HTTP GET response from the | |
| | | | | CAPIF core function to the API invoker | |
| | | | | (discovery API). | |
| aefProfiles | array(AefProfile) | M | 1 . . . N | AEF profile information, which includes the | |
| | | | | exposed API details (e.g. protocol). | |
| description | string | O | 0 . . . 1 | Text description of the API | |
| supportedFeatures | Supported | O | 0 . . . 1 | The supported optional features of the | |
| | Features | | | CAPIF API. (NOTE) | |
| shareableInfo | Shareable | O | 0 . . . 1 | Represents whether the service API and/or | |
| | Information | | | the service API category can be published | |
| | | | | to other CCFs. | |
| serviceAPICategory | string | O | 0 . . . 1 | The service API category to which the | |
| | | | | service API belongs to. | |
| apiSuppFeats | Supported | O | 0 . . . 1 | The features supported by the service API | ApiSupportedFea- |
| | Features | | | indicated by the apiId attribute. | turePublishing |
| pubApiPath | Published | C | 0 . . . 1 | It contains the published API path within the | |
| | ApiPath | | | same CAPIF provider domain, it shall be | |
| | | | | provided by the CCF when publishing the | |
| | | | | service API to other CCF via the | |
| | | | | CAPIF-6/6e reference point. | |

(NOTE):
For CAPIF_Publish_Service_API, the supported features attribute shall be provided in the HTTP POST request and in the response of successful resource creation. In addition, the supportedFeatures attribute may include one or more the supported features as defined in subclause 8.2.6.

The attribute “pubApiPath” contains identifiers of CCF entities that have published the API. For example, the data type “PublishedApiPath” can be defined in Table 3 below:

TABLE 3
Definition of type PublishedApiPath

| | | | | | |
|---|---|---|---|---|---|
| Attribute | | | | | Applica- |
| name | Data type | P | Cardinality | Description | bility |

| | | | | |
|---|---|---|---|---|
| ccfIds | array(string) | O | 1 . . . N | A list of CCF |
| | | | | identifiers. |

For further details of other IEs in Table 1 and other attributes in Table 2, reference can be made to Table 8.25.2.1-1 of TS 23.222 and Table 8.2.4.2.2-1 of TS 29.222, respectively, and details thereof will be omitted here.

When an identifier of the first network entity is included in the first list, at block 420, an API publish response indicating failure of publishing of the service API is transmitted to the second network entity, without creating a new resource for the service API at the first network entity or further publishing the service API to any network entity. That is, when the identifier of the first network identity is included the API path, it means that the service API published in the first API publish request is a service API the first entity has published. In this case, the first network entity will not create any new resource for the same service API or further publish the service API to any network entity, thereby avoiding a waste of resources and a loop for API publishing. Here, the API publish response can be an interconnection API publish response as specified in Section 8.25.2.2 of TS 23.222.

On the other hand, when the identifier of the first network entity is not included in the first list, at block 430, a second API publish request for publishing the service API is transmitted to a third network entity (e.g., a CCF entity). The second API publish request contains a second list of identifiers of network entities obtained by adding the identifier of the first network entity to the first list.

In an example, in the block 430, the second API publish request can be transmitted in response to determining that an identifier of the third network entity is not included in the first list. In other words, if the first network entity knows the identifier of the third network entity and determines that the identifier of the third network entity is included in the first list, meaning that the service API is a service API the third entity has published, the first network entity may not transmit the second API publish request to further publish the same service API to the third network entity, thereby avoiding a waste of resources and a loop for API publishing.

Further, when the identifier of the first network entity is not included in the first list, the first network entity can create a new resource for the service API at the first network entity; and transmit, to the second network entity, an API publish response indicating success of publishing of the service API and containing an identifier of the created new resource. Here, the API publish response can be an interconnection API publish response as specified in Section 8.25.2.2 of TS 23.222.

In an example, the first network entity, the second network entity, the third network entity, and the network entities that have published the service API may all be in one single CAPIF provider domain. In another example, these network entities may belong to different CAPIF provider domains.

In an implementation, the method 400 may include only the blocks 410 and 420. In another implementation, the method 400 may include only the blocks 410 and 430. In yet another implementation, the method 400 may include the blocks 410, 420 and 430.

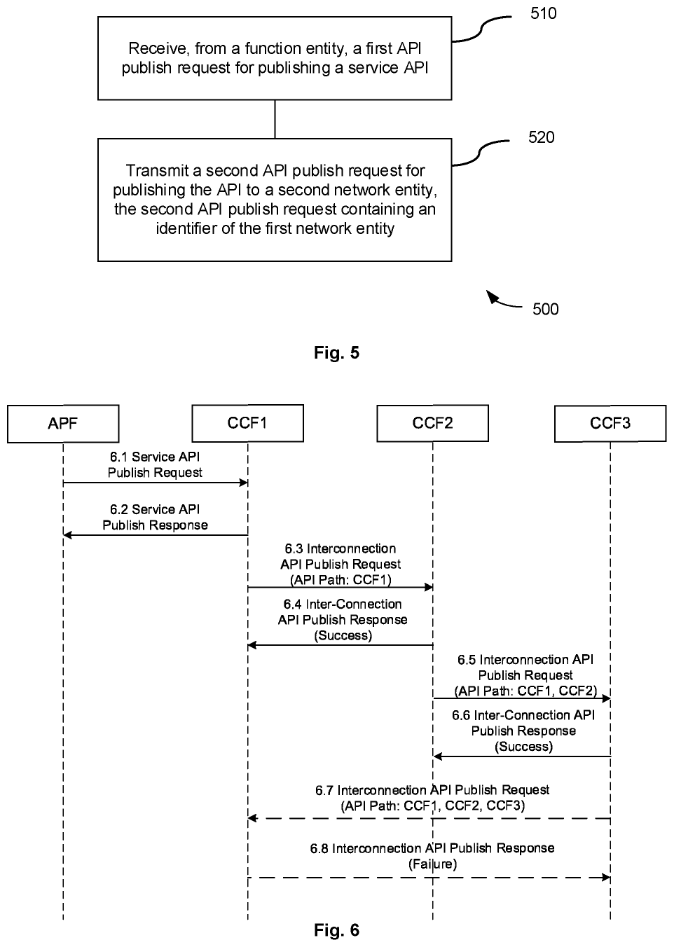

FIG. 5 is a flowchart illustrating a method 500 for service API publishing according to an embodiment of the present disclosure. The method 500 can be performed at a first network entity, e.g., a CCF entity.

At block 510, a first API publish request for publishing a service API is received from a function entity (e.g., an APF entity). The first API publish request can be e.g., a service API publish request as specified in Section 8.3.2.1 of TS 23.222.

At block 520, a second API publish request for publishing the API is transmitted to a second network entity (e.g., a CCF entity), e.g., in response to the first API publish request containing no API path. The second API publish request contains an identifier of the first network entity, e.g., in an API path. The second API publish request can be an interconnection API publish request according to Table 1 and contain “pubApiPath” according to Table 2.

Here, as the first API publish request contains no API path, the first network entity can create a new resource for the service API at the first network entity, and transmit, to the function entity, an API publish response indicating success of publishing of the service API and containing an identifier of the created new resource. Here, the API publish response can be a service API publish response as specified in Section 8.3.2.2 of TS 23.222.

In an example, the first network entity and the second network entity can be both in one single CAPIF provider domain. In another example, these network entities may belong to different CAPIF provider domains.

FIG. 6 is a sequence diagram showing an exemplary process for service API publishing according to an embodiment of the present disclosure. The process can be performed in a communication system including at least an APF entity and a plurality of CCF entities (e.g., CCF1, CCF2, and CCF3).

At 6.1, the APF entity transmits a service API publish request for publishing a service API to CCF1. As the service API publish request from the APF entity contains no API path, CCF1 creates a new resource for the service API and transmits a service API publish response indicating success of publishing of the service API and containing an identifier of the created new resource to the APF entity at 6.2. At 6.3, if the service API is to be shared with CCF2 (depending on Sharable Information in the service API publish request), CCF1 transmits an interconnection API publish request for publishing the service API to CCF2, containing an API path including an identifier of CCF1. Upon receiving the interconnection API publish request, CCF2 checks the API path and determines that an identifier of CCF2 is not included in the API path. Accordingly, CCF2 creates a new resource for the service API and transmits an interconnection API publish response indicating success of publishing of the service API and containing an identifier of the created new resource to CCF1 at 6.4. If the service API is to be shared with CCF3 (depending on Sharable Information in the interconnection API publish request from CCF1), CCF2 may first determine whether an identifier of CCF3 is included in the API path, if it is known to CCF2. If the identifier of CCF3 is known and not included in the API path, or if the identifier of CCF3 is unknown to CCF2, at 6.5, CCF2 transmits an interconnection API publish request for publishing the service API to CCF3, containing an API path including the identifiers of CCF1 and CCF2. Upon receiving the interconnection API publish request, CCF3 checks the API path and determines that the identifier of CCF3 is not included in the API path. Accordingly, CCF3 creates a new resource for the service API and transmits an interconnection API publish response indicating success of publishing of the service API and containing an identifier of the created new resource to CCF2 at 6.6.

If the service API is to be shared with CCF1 (depending on Sharable Information in the interconnection API publish request from CCF2), CCF3 may first determine whether the identifier of CCF1 is included in the API path, if it is known to CCF3. If the identifier of CCF1 is known and included in the API path, CCF3 will not further publish the service API back to CCF1 and there will be no loop accordingly. However, if the identifier of CCF1 is unknown to CCF3, at 6.7, CCF3 transmits an interconnection API publish request for publishing the service API to CCF1, containing an API path including the identifiers of CCF1, CCF2, and CCF3. Upon receiving the interconnection API publish request, CCF1 checks the API path and determines that the identifier of CCF1 is included in the API path. Accordingly, CCF1 transmits an interconnection API publish response indicating failure of publishing of the service API to CCF3 at 6.8, without creating a new resource for the service API at CCF1 or further publishing the service API to any network entity. In this case, there will be no loop for publishing the service API.

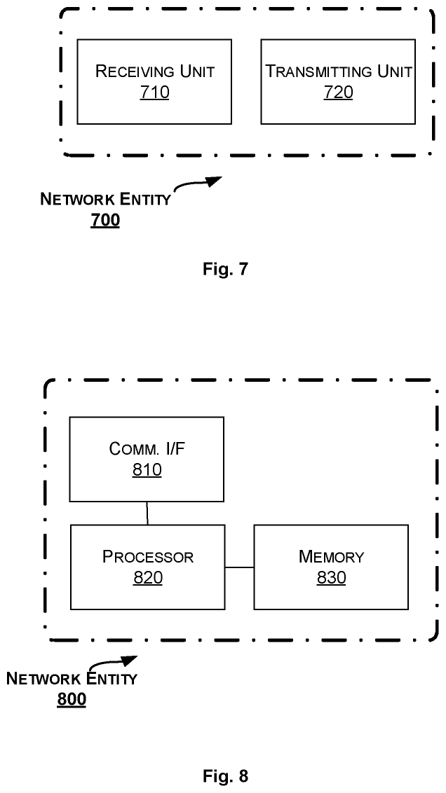

Correspondingly to the method 400 or 500 as described above, a first network entity is provided. FIG. 7 is a block diagram of a first network entity 700 according to an embodiment of the present disclosure.

The first network entity 700 can be operative to perform the method 400 as shown in FIG. 4. As discussed above in connection with the method 400, in an implementation, the first network entity 700 can be operative to perform only the blocks 410 and 420 in the method 400. In another implementation, the first network entity 700 can be operative to perform only the blocks 410 and 430 in the method 400. In yet another implementation, the first network entity 700 can be operative to perform the blocks 410, 420 and 430 in the method 400.

As shown in FIG. 7, the first network entity 700 includes a receiving unit 710 configured to receive, from a second network entity, a first API publish request for publishing a service API, the first API publish request containing a first list of identifiers of network entities that have published the service API.

The first network entity 700 further includes a transmitting unit 720 configured to transmit, when an identifier of the first network entity is included in the first list, an API publish response indicating failure of publishing of the service API to the second network entity. In this case, the first network entity 700 will not create a new resource for the service API at the first network entity or further publish the service API to any network entity.

Alternatively or additionally, the transmitting unit 720 can be configured to transmit, when an identifier of the first network entity is not included in the first list, a second API publish request for publishing the service API to a third network entity, the second API publish request containing a second list of identifiers of network entities obtained by adding the identifier of the first network entity to the first list. In this case, the second API publish request may be transmitted in response to determining that an identifier of the third network entity is not included in the first list. The first network entity 700 can further include a creating unit configured to create a new resource for the service API at the first network entity, and the transmitting unit 720 can be further configured to transmit, to the second network entity, an API publish response indicating success of publishing of the service API and containing an identifier of the created new resource.

In an embodiment, each of the first network entity, the second network entity, the third network entity, and the network entities that have published the service API may be a CCF entity.

In an embodiment, the first network entity, the second network entity, the third network entity, and the network entities that have published the service API may all be in one single CAPIF provider domain.

Alternatively, the network entity 700 can be operative to perform the method 500 as shown in FIG. 5. As shown in FIG. 7, the network entity 700 includes a receiving unit 710 configured to receive, from a function entity, a first API publish request for publishing a service API. The network entity 700 further includes a transmitting unit 720 configured to transmit a second API publish request for publishing the API to a second network entity, the second API publish request containing an identifier of the first network entity.

In an embodiment, each of the first network entity and the second network entity may be a CCF entity, and the function entity may be an APF entity.

In an embodiment, the first network entity and the second network entity may both be in one single CAPIF provider domain.

The units 710 and 720 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 4 or 5.

FIG. 8 is a block diagram of a first network entity 800 according to another embodiment of the present disclosure.

The first network entity 800 includes a communication interface 810, a processor 820 and a memory 830. The memory 830 may contain instructions executable by the processor 820 whereby the first network entity 800 is operative to perform the actions, e.g., of the procedure described earlier in conjunction with FIG. 4. As discussed above in connection with the method 400, in an implementation, the first network entity 800 can be operative to perform only the blocks 410 and 420 in the method 400. In another implementation, the first network entity 800 can be operative to perform only the blocks 410 and 430 in the method 400. In yet another implementation, the first network entity 800 can be operative to perform the blocks 410, 420 and 430 in the method 400.

Particularly, the memory 830 contains instructions executable by the processor 820 whereby the first network entity 800 is operative to receive, from a second network entity, a first API publish request for publishing a service API, the first API publish request containing a first list of identifiers of network entities that have published the service API.

The memory 830 may further contain instructions executable by the processor 820 whereby the first network entity 800 is operative to transmit, when an identifier of the first network entity is included in the first list, an API publish response indicating failure of publishing of the service API to the second network entity, without creating a new resource for the service API at the first network entity or further publishing the service API to any network entity.

Alternatively or additionally, the memory 830 may further contain instructions executable by the processor 820 whereby the first network entity 800 is operative to transmit, when an identifier of the first network entity is not included in the first list, a second API publish request for publishing the service API to a third network entity, the second API publish request containing a second list of identifiers of network entities obtained by adding the identifier of the first network entity to the first list. In an embodiment, the second API publish request may be transmitted in response to determining that an identifier of the third network entity is not included in the first list. In an embodiment, the memory 830 may further contain instructions executable by the processor 820 whereby the first network entity 800 is operative to, when the identifier of the first network entity is not included in the first list: create a new resource for the service API at the first network entity; and transmit, to the second network entity, an API publish response indicating success of publishing of the service API and containing an identifier of the created new resource.

In an embodiment, each of the first network entity, the second network entity, the third network entity, and the network entities that have published the service API may be a CCF entity.

In an embodiment, the first network entity, the second network entity, the third network entity, and the network entities that have published the service API may all be in one single CAPIF provider domain.

Alternatively, the memory 830 may contain instructions executable by the processor 820 whereby the first network entity 800 is operative to perform the actions, e.g., of the procedure described earlier in conjunction with FIG. 5. Particularly, the memory 830 contains instructions executable by the processor 820 whereby the first network entity 800 is operative to receive, from a function entity, a first API publish request for publishing a service API; and transmit a second API publish request for publishing the API to a second network entity, the second API publish request containing an identifier of the first network entity.

In an embodiment, each of the first network entity and the second network entity may be a CCF entity, and the function entity may be an APF entity.

In an embodiment, the first network entity and the second network entity may both be in one single CAPIF provider domain.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 820 causes the network entity 800 to perform the actions, e.g., of the procedure described earlier in conjunction with FIG. 4 or 5.

The computer program product may be configured as a computer program code structured in computer program modules. The computer program modules could essentially perform the actions of the flow illustrated in FIG. 4 or 5.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random Access Memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1-10. (canceled)

11. A method in a first network entity for service Application Programming Interface, API, publishing, comprising:
receiving, from a second network entity, a first API publish request for publishing a service API, the first API publish request containing a list of identifiers of network entities that have published the service API;
transmitting, when an identifier of the first network entity is included in the list, an API publish response indicating failure of publishing of the service API to the second network entity, without creating a new resource for the service API at the first network entity and without further publishing the service API to any network entity; and
transmitting, when an identifier of the first network entity is not included in the first list, a second API publish request for publishing the service API to a third network entity, the second API publish request containing a second list of identifiers of network entities obtained by adding the identifier of the first network entity to the first list.

12. The method of claim 11, wherein said transmitting is in response to determining that an identifier of the third network entity is not included in the first list.

13. The method of claim 11, further comprising, when the identifier of the first network entity is not included in the first list:
creating a new resource for the service API at the first network entity; and
transmitting, to the second network entity, an API publish response indicating success of publishing of the service API and containing an identifier of the created new resource.

14. The method of claim 11, wherein each of the first network entity, the second network entity, the third network entity, and the network entities that have published the service API is a Common API Framework ‘CAPIF’ Core Function, CCF, entity.

15. The method of claim 14, wherein the first network entity, the second network entity, the third network entity, and the network entities that have published the service API are all in one single CAPIF provider domain.

16. A first network entity comprising a communication interface, a processor and a memory, the memory comprising instructions executable by the processor whereby the first network entity is operative to:
receive, from a second network entity, a first API publish request for publishing a service API, the first API publish request containing a list of identifiers of network entities that have published the service API;
transmit, when an identifier of the first network entity is included in the list, an API publish response indicating failure of publishing of the service API to the second network entity, without creating a new resource for the service API at the first network entity and without further publishing the service API to any network entity; and
transmit, when an identifier of the first network entity is not included in the first list, a second API publish request for publishing the service API to a third network entity, the second API publish request containing a second list of identifiers of network entities obtained by adding the identifier of the first network entity to the first list.

17. The first network entity of claim 16, wherein the first network entity is operable to determine that an identifier of the third network entity is not included in the first list.

18. The first network entity of claim 16, wherein, when the identifier of the first network entity is not included in the first list the first network entity is operable to:
create a new resource for the service API at the first network entity; and
transmit, to the second network entity, an API publish response indicating success of publishing of the service API and containing an identifier of the created new resource.

19. The first network entity of claim 16, wherein each of the first network entity, the second network entity, the third network entity, and the network entities that have published the service API is a Common API Framework ‘CAPIF’ Core Function, CCF, entity.

20. The first network entity of claim 19, wherein the first network entity, the second network entity, the third network entity, and the network entities that have published the service API are all in one single CAPIF provider domain.

21. A computer readable storage medium having computer program instructions stored thereon, the computer program instructions, when executed by a processor in a first network entity, causing the first network entity to:
receive, from a second network entity, a first API publish request for publishing a service API, the first API publish request containing a list of identifiers of network entities that have published the service API; and
transmit, when an identifier of the first network entity is included in the list, an API publish response indicating failure of publishing of the service API to the second network entity, without creating a new resource for the service API at the first network entity and without further publishing the service API to any network entity; and
transmit, when an identifier of the first network entity is not included in the first list, a second API publish request for publishing the service API to a third network entity, the second API publish request containing a second list of identifiers of network entities obtained by adding the identifier of the first network entity to the first list.

22. The computer readable storage medium of claim 21, wherein the computer program instructions, when executed by the processor in a first network entity, cause the first network entity to determine that an identifier of the third network entity is not included in the first list.

23. The computer readable storage medium of claim 21, wherein, when the identifier of the first network entity is not included in the first list the first network entity is operable to:
create a new resource for the service API at the first network entity; and
transmit, to the second network entity, an API publish response indicating success of publishing of the service API and containing an identifier of the created new resource.

24. The computer readable storage medium of claim 21, wherein each of the first network entity, the second network entity, the third network entity, and the network entities that have published the service API is a Common API Framework ‘CAPIF’ Core Function, CCF, entity.

25. The computer readable storage medium of claim 24, wherein the first network entity, the second network entity, the third network entity, and the network entities that have published the service API are all in one single CAPIF provider domain.
